(19) United States
(12) Patent Application Publication
(10) Pub. No.: US 2009/0160726 A1
(43) Pub. Date: Jun. 25, 2009

(54) ANTENNA MODULE AND A POSITIONING DEVICE THEREOF

(76) Inventor: Chien-Ming Peng, Hsichih (TW)

Correspondence Address: BIRCH STEWART KOLASCH & BIRCH, PO BOX 747, FALLS CHURCH, VA, 22040-0747, US

(21) Appl. No.: 12/211,210

(22) Filed: Sep. 16, 2008

(30) Foreign Application Priority Data
Dec. 19, 2007 (TW) 096148761

(51) Int. Cl. H01Q 1/12

(52) U.S. Cl. 343/880

(57) ABSTRACT

An antenna module and a positioning device thereof. The antenna module includes a base, a frame, a plurality of antenna set and an antenna positioning device. The antenna positioning device includes a plurality of engaging sockets. Each of the antenna set has a back plate. Each of the engaging sockets has a back plate connecting portion and a frame connecting portion disposed at the back side of the back plate connecting portion, wherein the back plate connecting portion is connected to the back plate. The side of the frame has a plurality of connecting sections disposed corresponding to those frame connecting portions, wherein the edge of those connecting sections are connected with the frame. When those connecting sections are connected with those frame connecting portions, the frame connects each of those engaging sockets and assembles those back plates to form the antenna module.

This application claims benefit to a Taiwanese Patent Application No. 096148761, filed on Dec. 19, 2007.

### BACKGROUND OF THE INVENTION

1. Field of the Invention

The present invention relates generally to an antenna module and a positioning device thereof. Particularly, the present invention relates to an antenna positioning device for assembling the plural antennas to form a multi-directional antenna module.

2. Description of the Prior Art

Antenna plays an important role in the construction of a wireless network. The antenna is also an indispensable component of the wireless electronic products such as Access Point, signal relay, wireless connecting component, GPS, etc. Considering the fact that wireless signal is affected by a variety of elements such as distance, direction, geographical condition, etc, thus antenna manufacturers keep providing new products to satisfy consumer's tastes. The directional antennae such as Patch antennae have greater directivity and thus became one of the many widely used antennas.

With reference to FIG. 1 it illustrates the cross-sectional view of a conventional wireless signal receptor having a Patch Antenna. FIG. 1 shows that a Patch antenna 30 is disposed within the wireless signal receptor 10. Although Patch antenna 32 is coupled horizontally with the Patch 32 on the ground surface 31, which allows the Patch Antenna 30 to have the maximal Antenna Gain in the orthogonal position of Patch Antenna 30 corresponding to the signal source. However, due to the single signal sensing direction of the Patch Antenna 30, the more complicated topography such as urban area or resident area may reduce sensibility of Patch Antenna. Besides, although most of the wireless signal receptors use Dipole Antenna to achieve omni-directional reception, the signal quality and stability of Dipole Antenna still requires a lot of improvement.

### SUMMARY OF THE INVENTION

It is an object of the present invention to provide an antenna module and a positioning device thereof to achieve not only the maximal Antenna Gain in omni-direction but also to reduce the influence of complicated topography and disadvantage of wireless signal transmission in complicated urban area.

It is another object of the present invention to provide an antenna module and a positioning device thereof. Such antenna module and the positioning device thereof achieve its maximal Antenna Gain by modulating and assembling antenna positioning device to form antennae such as Patch Antenna.

It is a further object of the present invention to provide an antenna module and a positioning device thereof to provide a solution for unstable wireless signal transmission in the complicated topography such as urban area.

It is yet another object of the invention to provide an antenna module and a positioning device thereof. One assembly design of the invention is to assemble antennas on a wireless communication product.

The antenna module of the present invention and a positioning device thereof includes a base, a frame, a plurality of antenna sets and an antenna positioning device, wherein the base has an axle, each of antenna has a back plate, the antenna positioning device includes plural engaging sockets, each of the engaging sockets has a back plate connecting portion and a frame connecting portion which is disposed at the back side of the back plate connecting portion. The back plate connecting portion engages with the back plate. The side of the frame has a plurality of connecting sections disposed corresponding to the frame connecting portion, wherein the edge of the connecting sections connects with the frame. When each of the connecting sections engages with each of the frame connecting portions, frame engages with the engaging sockets and supports the back plates.

In the embodiment, each of the engaging sockets further has a first flexible arm and a second flexible arm. Thus, the antenna positioning device of the present invention connects the antenna, such as Patch Antenna, with the frame by using the engaging socket. Thus, the engaging socket is sandwiched between antenna and the frame. Simultaneously, the first flexible arm and the second flexible arm of the engaging socket engage with the Patch Antenna and the frame, respectively. By doing so, it is not only useful to prevent disengaging the engaging socket from the frame but also make it quick to assemble.

One embodiment of the present invention also provides an antenna module and a manufacture method of the positioning device of the antenna module. The manufacture method includes several steps as the following: engaging the back plate connecting portion with the back plate, wherein each of the engaging sockets further includes a back plate connecting portion and a frame connecting portion which is disposed at the back side of the back plate connecting portion, the connecting sections are disposed on the side of the frame corresponding to the frame connecting portion; secondly, connecting the connecting sections with the frame connecting portion to connect the frame with the sockets by connecting sections and thus to support the back plate to form an antenna assembling; finally, assembling the antenna assembling with the base to form an antenna module.

### BRIEF DESCRIPTION OF THE DRAWINGS

FIG. 1 shows a cross-sectional view of traditional wireless signal receptor.

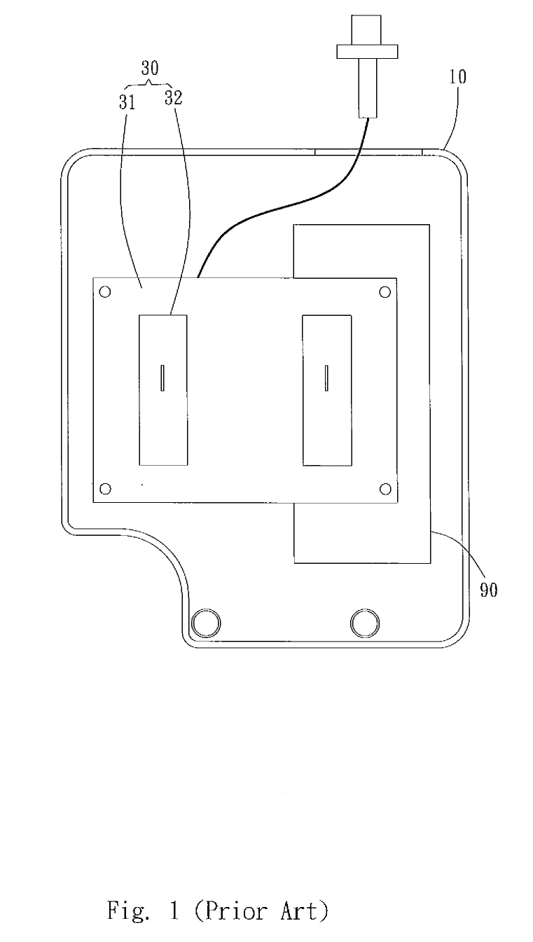

FIG. 2a shows a top view of an embodiment of the antenna module of the present invention and the positioning device thereof.

FIG. 2b shows a perspective view of an embodiment of the antenna module of the present invention and the positioning device thereof.

FIG. 3a illustrates an exploded view of the embodiment in FIG. 2a and FIG. 2b.

FIG. 3b shows an embodiment of the antenna module of the present invention and the positioning device thereof.

FIG. 3c illustrates an embodiment of the antenna module of the present invention and the positioning device thereof.

FIG. 3d illustrates an embodiment of the antenna module of the present invention and the positioning device thereof.

FIG. 4 illustrates an embodiment of the antenna module of the present invention and a positioning device thereof.

FIG. 5a illustrates an embodiment of the antenna module of the present invention and a positioning device thereof.

FIG. 5b illustrates an embodiment of the antenna module of the present invention and a positioning device thereof.

FIG. 6 illustrates an embodiment of the antenna module of the present invention and a positioning device thereof.

FIG. 7 illustrates a flow chart of the manufacture method of the antenna module and the positioning device thereof.

### DETAILED DESCRIPTION OF THE PREFERRED EMBODIMENT

One embodiment of the present invention provides an antenna module and a positioning device thereof. The antenna module of the embodiment of the present invention couples with electronic components such as wireless signal receptor and so on. The antenna positioning device can be used to assemble plural antenna sets to form an antenna assembling to couple with electromagnetic energy in the free space. Under several situations, in order for the wireless transmission to have better quality and stability, it is necessary for antenna to magnify transmitted signal in certain directions in order to reach the maximal Antenna Gain. Thus, in the embodiment, the antenna module of the embodiment of the present invention assembles plural antenna sets in an array in order to achieve the multi-directional Max Antenna Gain. By doing so, the disturbance of directivity and topology on wireless signal transmission is reduced.

The multi-directional Max Antenna Gain means that Patch Antenna is a directional antenna with directivity. Thus, orthogonal surface of Patch Antenna, disposed horizontally on the ground, will have Max Antenna Gain corresponding to transmitted signals. Thus, the antenna module of the embodiment of the present invention uses a frame and an antenna positioning device to assemble Patch Antenna to have maximal receptive coverage. In other words, the orthogonal surface of Patch Antenna has Max Antenna Gain corresponding to the resource which facilitates the antenna module to achieve the maximal signal coverage. The antenna module of the embodiment of the present invention can be a type of Patch Antenna. In addition, in other embodiments, other types of antennas could also be assembled.

Because the antenna module of the embodiment of the present invention has larger signal coverage, the antenna module of the embodiment of the present invention is applied for Bridge in the WAN (Wireless Area Network). More particularly, it will be ideal to be used in areas such as the block in the street, commodious warehouse, factory and so on. Furthermore, because of the multi-directional Max Antenna Gain of the present invention, the embodiment of the present invention is applied in the urban area to provide a space arrangement solution for unstable wireless signal transmission in complicated topography.

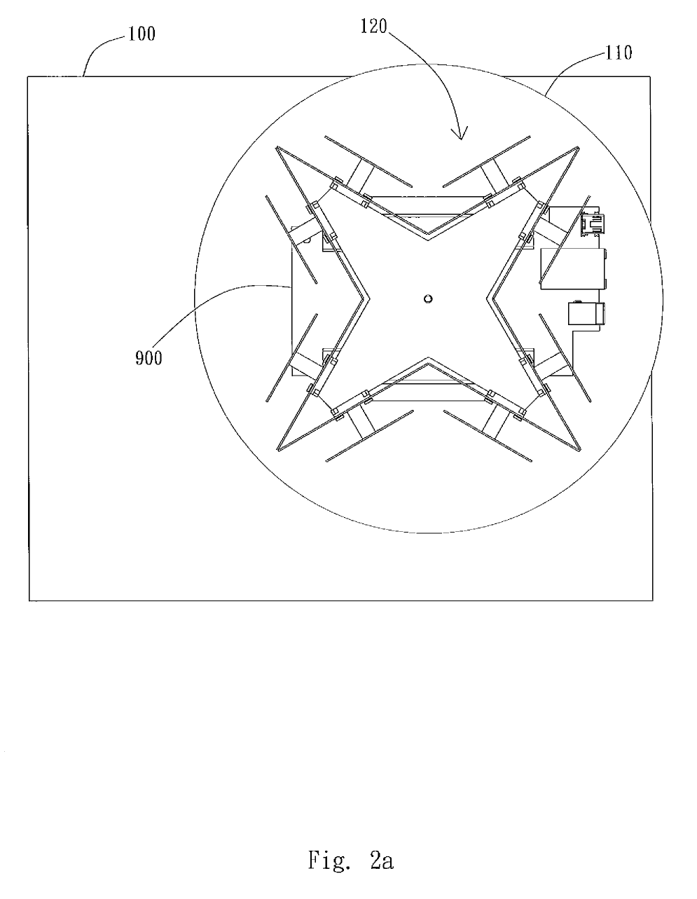

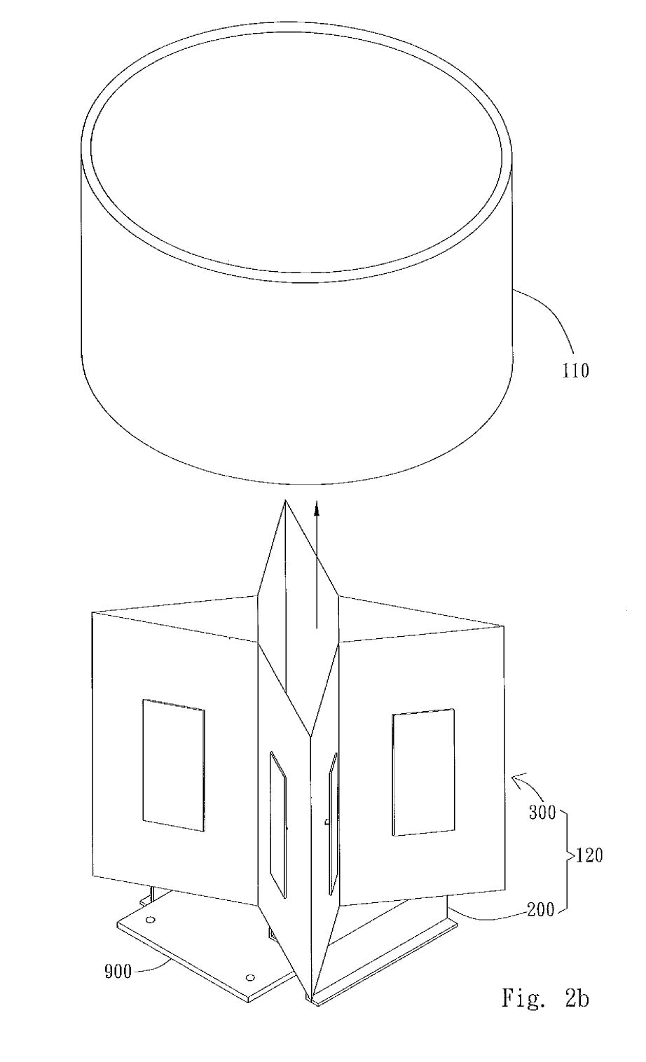

The embodiment of the antenna module of the embodiment of the present invention and the positioning device thereof is shown in FIG. 2a and FIG. 2b. With reference to FIG. 2a, the antenna module 120 of the embodiment of the present invention couples with the electronic component 100. The electronic device 100 has a printed circuit board 900 and an antenna shield 110. The antenna module 120 is disposed in the antenna shield 110 and connects to the printed circuit board 900. In the embodiment shown in FIG. 2b, the antenna module 120 includes a base 200, a frame (not shown in FIG. 2b) and an antenna assembling 300 disposed on the base 200. The wireless receptor of the embodiment of the present invention includes but not necessarily be restrained to an Access Point, signal relay, wireless connecting component, GPS or other electronic devices which need wireless electronic receptors.

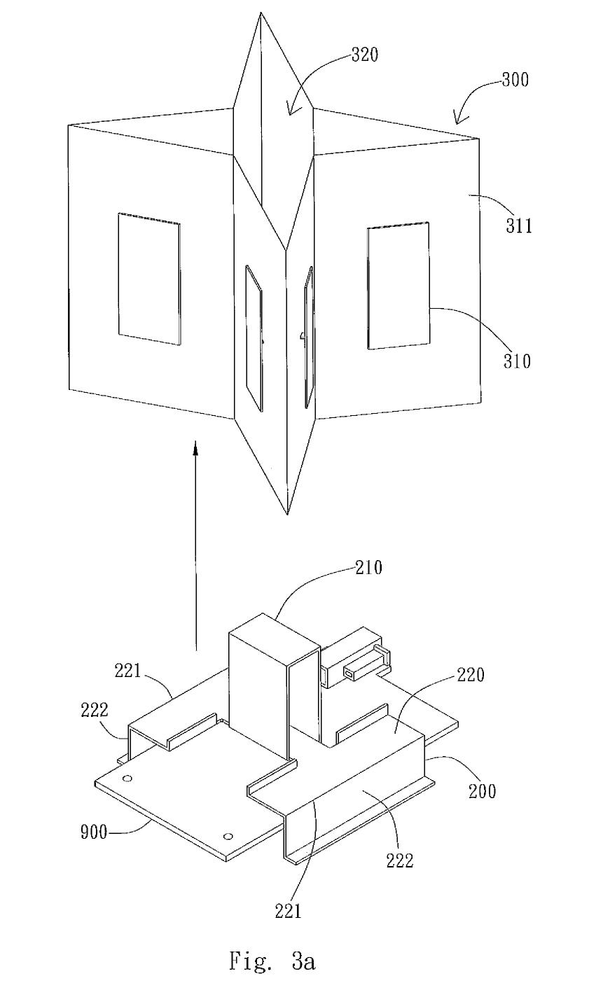

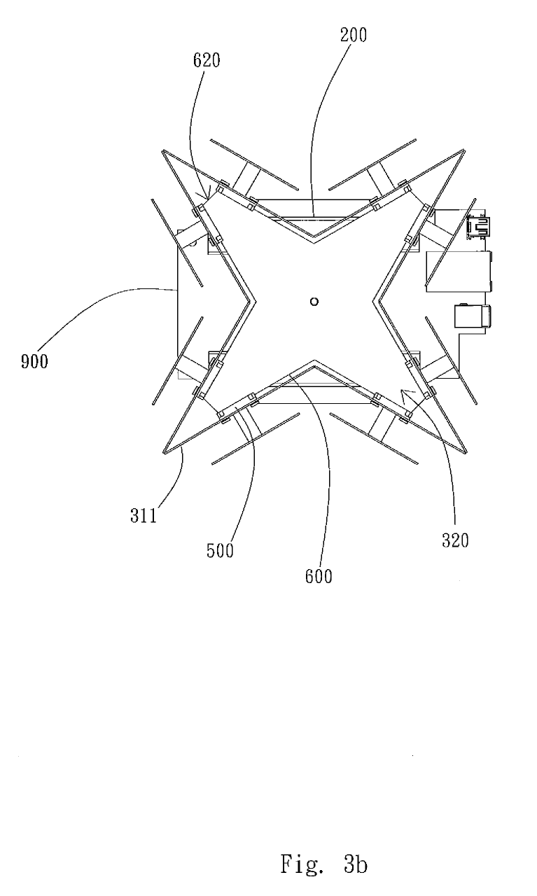

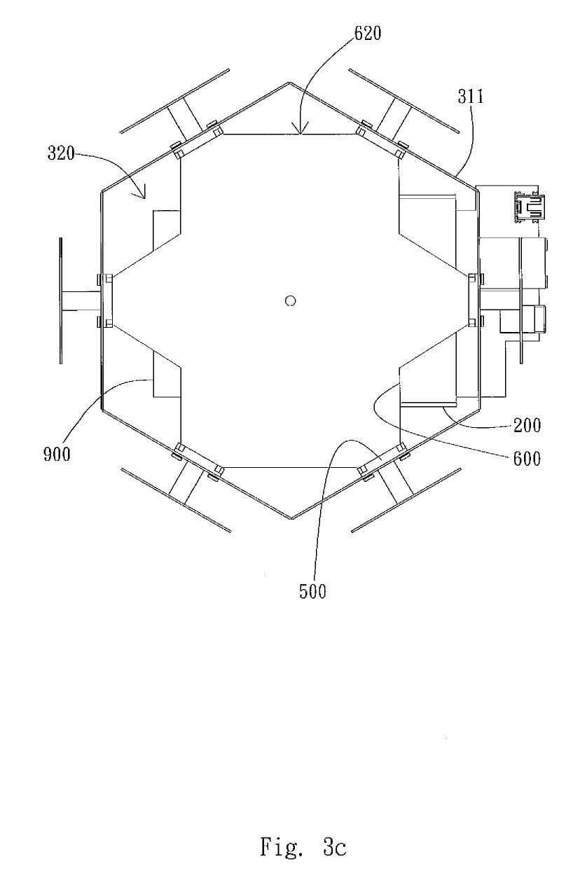

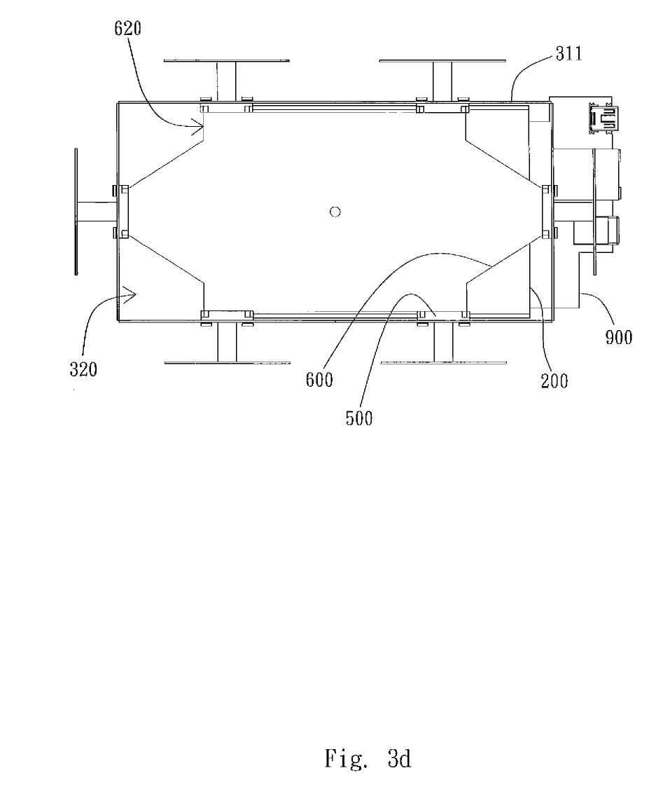

With reference to FIG. 3a, the base 200 has an H-shaped upper surface 220. Two sides 221 of the H-shaped upper surface 220 connect the support part 222 which extends downwards, respectively. By doing so, it allows the base 200 be disposed over the printed circuit board 900. However, in other embodiments, the shape and size of base 200 are adjusted according to the size of the printed circuit board 900 and the shape of the antenna shied 110. In the embodiment shown in FIG. 3a and FIG. 3b, the base 200 has an axle 210. A frame 600 is disposed on the base 200. There are plural antenna sets 310 disposed on the base 200 and assembled to form the three-dimensional structure of the antenna assembling 300. In the embodiment shown in FIG. 3a, the antenna sets 310 are disposed on the frame 600 by using the antenna positioning device so that the antenna sets 310 is disposed around the axle 210. With reference to FIG. 3b, the antenna assembling 300 includes an enclosure area 320. The axle 210 is disposed inside the enclosure area 320 to connect the antenna assembling 300 to the base 200.

With reference to FIG. 3b and FIG. 3a, because the antenna assembling 300 is assembled in a star-shape by using the frame 600, the enclosure area 320 of the antenna assembling 300 is formed as a star-shaped cross-section. However, in other embodiments, because the embodiment of the present invention of the antenna assembling 300 can be flexibly adjusted according to different demands and signal receptive directions. With reference to FIG. 3c and FIG. 3d, the antenna assembling 300 includes a polygon shape adjusted according to the different shapes and sizes of the frame 600. By doing so, the enclosure area 320 has a polygon-shaped cross-section. In the embodiment shown in FIG. 3a and FIG. 3d, the assembled antenna assembling 300 is disposed on the base 200. The disposition method aims for ease of assembly and to quick disassemble. Such method can also be performed by screws and rivets other similar fixing method.

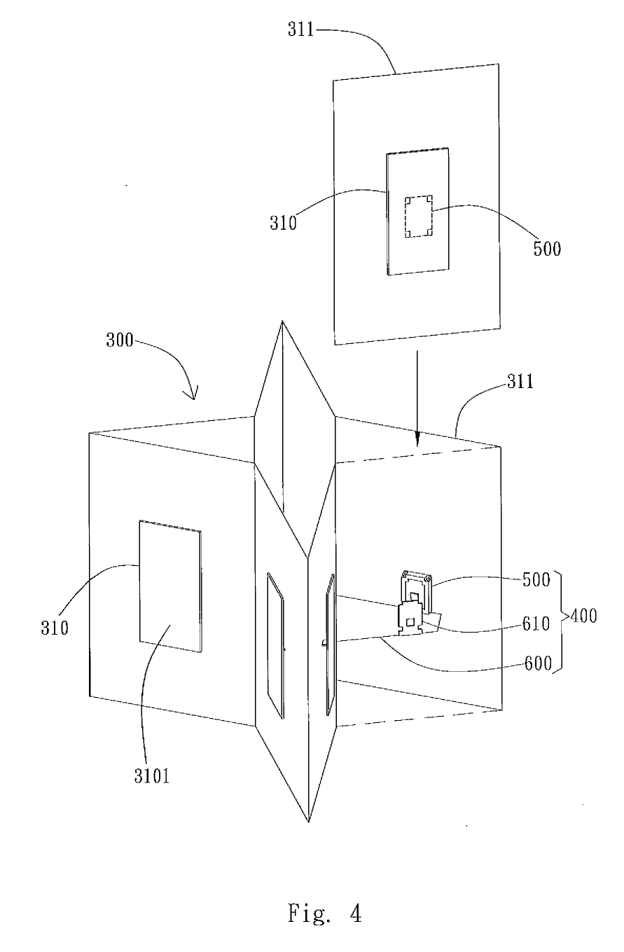

Besides, because the size of the antenna under certain frequencies and their designs of arrangement, the efficiency of signals in directions, the antenna shield, types of array and number of the antenna sets are different, it is difficult to fix the antenna on the shield so as to restrain the appearance design. However, the positioning device of the embodiment of the present invention provides a convenient design and an assembling method to allow the antenna assembling easy to assemble and to prevent the antenna module from plastic deformation and error of assembling change. In the embodiment shown in FIG. 4, the antenna assembling 300 is composed of plural antenna sets 310. Each of the antenna sets 310 respectively has an antenna 3101 and an antenna positioning device 400. In the embodiment, each of the antenna positioning devices 400 of the antenna sets 310 has a back plate 311 to position the antenna 3101. The antenna positioning device 400 includes a plurality of the engaging sockets 500 detachably connecting to the frame 600 to position the back plate 311 of the antenna sets 310. With reference to FIG. 4, the antenna positioning device 400 connects the antenna set 310 of the back plate 311 and the frame 600 through the engaging sockets 500. The engaging socket 500 is disposed on the back side of the back plate 311 and detachably connects to the side of the frame 600. By doing so, it allows the back plate 311, frame 600 and the engaging socket 500 to form a sandwich shape and to replace the general fixing method by screws and rivets to improve the assembling convenience and to achieve the purpose of quick assembling.

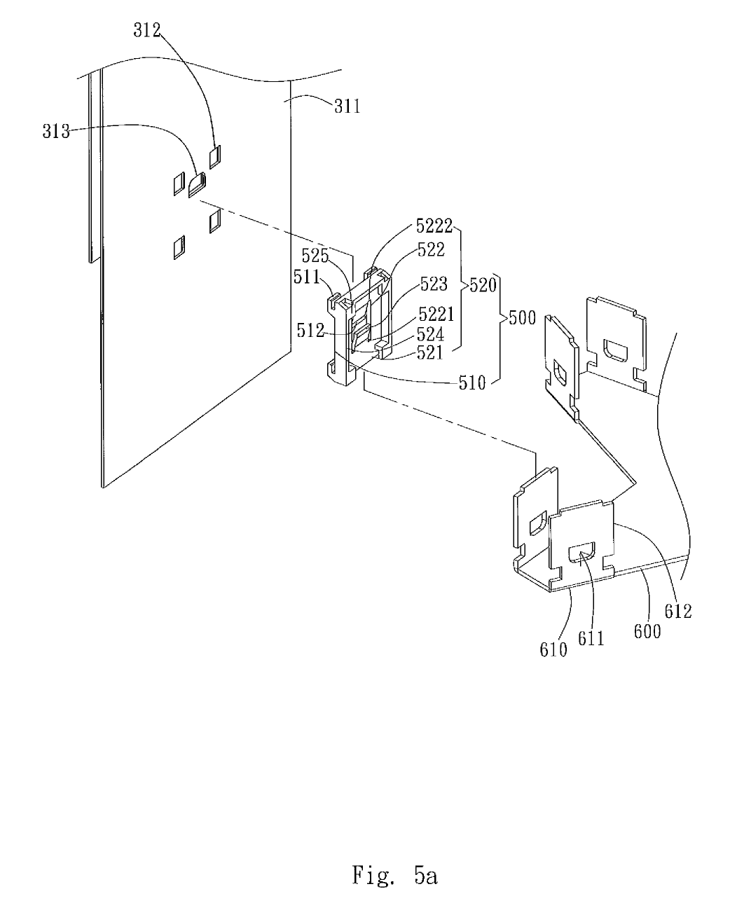

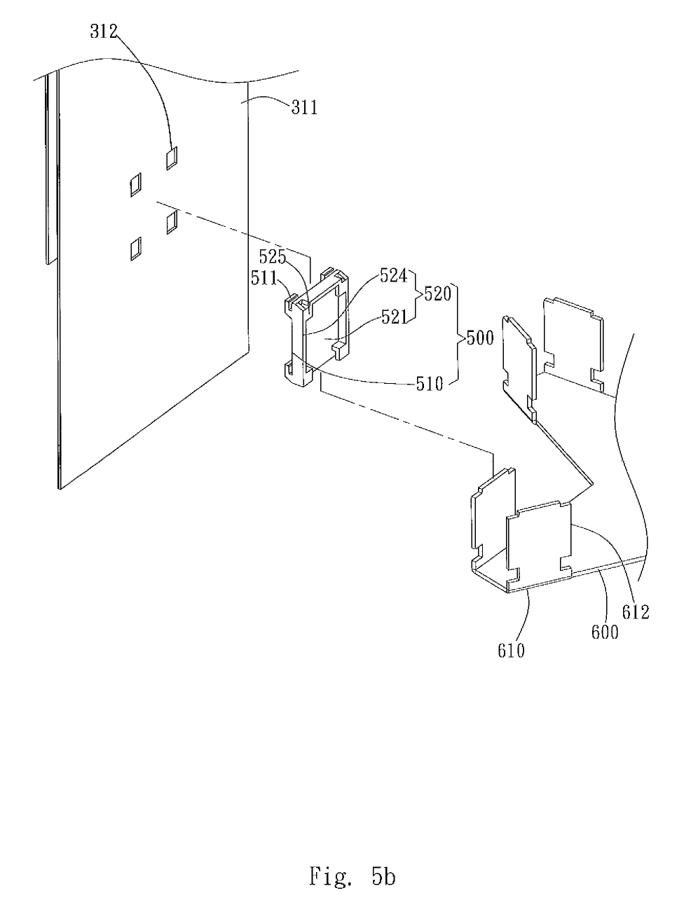

In the embodiment shown in FIG. 5a and FIG. 5b, each of the engaging sockets 500 has a back plate connecting portion 510 and a frame connecting portion 520 respectively disposed on the back side of the back plate connecting portion 510. In the present embodiment, the engaging sockets 500 are injection-molded plastic which detachably connects the back plate 311 through the back plate connecting portion 510. In the embodiment shown in FIG. 5a and FIG. 5b, the back plate 311 has at least a second opening 312. The back plate connecting portion 510 has at least a latch 511, wherein the latch 511 engages with the second opening 312 to detachably connect the back plate connecting portion 510 to the back plate 311. With reference to FIG. 5a and FIG. 5b, the latch 511 is formed as L-shape to detachably connect with the edge of the back plate connecting portion 510. However, in other embodiments, the latch 511 is also formed as inverted-L shape to engage with the second opening 312. Furthermore, in other embodiments, the position of the latch 511 and the second opening 312 can be switched. That means that the second opening 312 is formed on the edge of the back plate connecting portion 510. Simultaneously, the latch 611 can be compressed to be disposed close to the back plate 311. Thus, the latch 511 engages with the second opening 312 to position the engaging sockets 500 corresponding to the back plate 311.

With reference to FIG. 5a and FIG. 5b, plural connecting sections 610 are disposed on the side of the frame 600 corresponding to the frame connecting portion 520 to engage with the frame connecting portion 520, respectively. In the embodiment, the edge of the connecting section 610 detachably connects with the frame 600. When each of the connecting sections 610 engages with each of the frame connecting portion 520, the frame 600 detachably connects to the engaging sockets 500 and supports the back plate 311 to form an antenna assembling 300. In the embodiment shown in FIG. 5a, each of the engaging sockets 500 is disposed on the geometric center of each of the back plate 311. The edge of each of the connecting sections 610 is disposed on and detachably connected to the side of the frame 600. Thus, imaging that perpendicular direction of the side of the frame 600 has a putative section plate. Each of the connecting sections 610 is disposed on the putative section plate of the frame 600 and connects perpendicularly with the side of the frame 600. With reference to FIG. 3b and FIG. 4, when the connecting sections 610 engages with the frame connecting portion 520, part of the side of the frame 600 is proximally disposed next to the back plate 311.

In the embodiment, the frame 600 is formed as different shapes according to the arrangement of the antenna 311 of the antenna assembling 300. In the embodiment shown in FIG. 5a and FIG. 5b, the frame 600 is a bent plate material or a bent wire rod. In the bent plate case, please refer to FIG. 3b to FIG. 3d. In the embodiment shown in FIG. 3b, the frame of the embodiment of the present invention 600 is a slice plate material formed by compressing method. The plate material includes a polygon-shaped cross-section. However, in other embodiment, the frame 600 is a continuous wire rod. The continuous wire rod includes a flexible metal material. The frame 600 includes a star-shaped polygon frame body 620 formed by bending the continuous wire rod. However, in other embodiments shown in FIG. 3c and FIG. 3d, the frame 600 is bent to form a rectangle or polygon shapes frame body 620.

In the embodiment shown in FIG. 5a, the frame connecting portion 520 includes a first surface 521 and a first flexible arm 523. The connecting section 610 has a first opening 611. When the connecting section 610 detachably connects to the frame connecting portion 520 along the first surface 521, the first flexible arm 523 separably engages with the first opening 611. However, in other embodiments shown in FIG. 5b, the connecting part 610 directly engages with the frame connecting portion 520 without the first flexible arm 523. In the embodiment shown in FIG. 5a, the frame connecting portion 520 includes an inner side 522. The inner side 522 includes a first point 5221 and the second point 5222. The first flexible arm 523 detachably connects to the first point 5221 of the inner side 522. In the embodiment shown in FIG. 5a, the back plate 311 includes a third opening 313. The back plate connecting portion 510 includes a second flexible arm 512 detachably connecting to the second point 5222 of the inner side 522. When the latch 511 engages with the second opening 312, the second flexible arm 512 engages with the third opening 313. The engaging socket 500 separably connects to the back plate 311. With reference to FIG. 5a, the third opening 313 is disposed on the back plate 311 close to at least an second opening 312. However, in other embodiments, the position of the third opening 313 can be adjusted according to the position of the second flexible arm 512. Besides, in other embodiments shown in FIG. 5b, the engaging socket 500 is directly disposed on the frame connecting portion 520 without the second flexible arm 512.

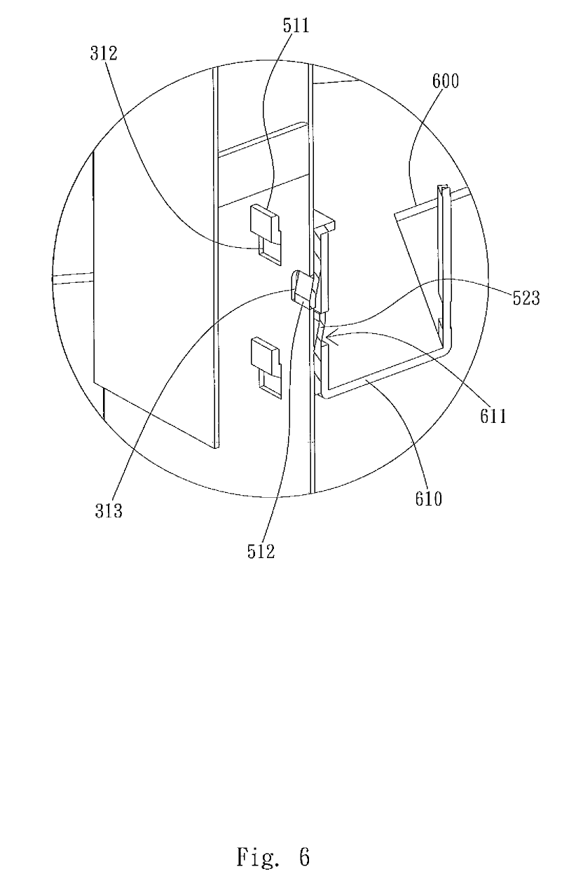

In the embodiment shown in FIG. 5a, each of frame connecting portion 520 further includes a lateral wall 524 around the side of the first surface 521. Each of the connecting sections 610 has at least a hook 612. With reference to FIG. 5a, the connecting corner between the lateral wall 524 and the first surface 521 has a plurality of positioning part 525. When the first flexible arm 523 engages with the first opening 611, two ends of at least a hook 612 detachably connect to the proximal two positioning part 525 to engage the connecting part 610 with the engaging socket 500. In the embodiment shown in FIG. 6, because the first flexible arm 523 and the second flexible arm 512 respectively intersects the inner side 522 by an angle, an extending direction of the first flexible arm 523 is parallel to an extending direction of the second flexible arm 512. In other words, the first flexible arm 523 and the second flexible arm 512 are intersected toward different directions to allow the back plate 311 to engage with the connecting section 610. Thus, the first flexible arm 523 and the second flexible arm 512 of the engaging socket 500 engage with the back plate 311 and the frame 600 of the antenna set 310 to prevent them from disassembling according to assembling direction.

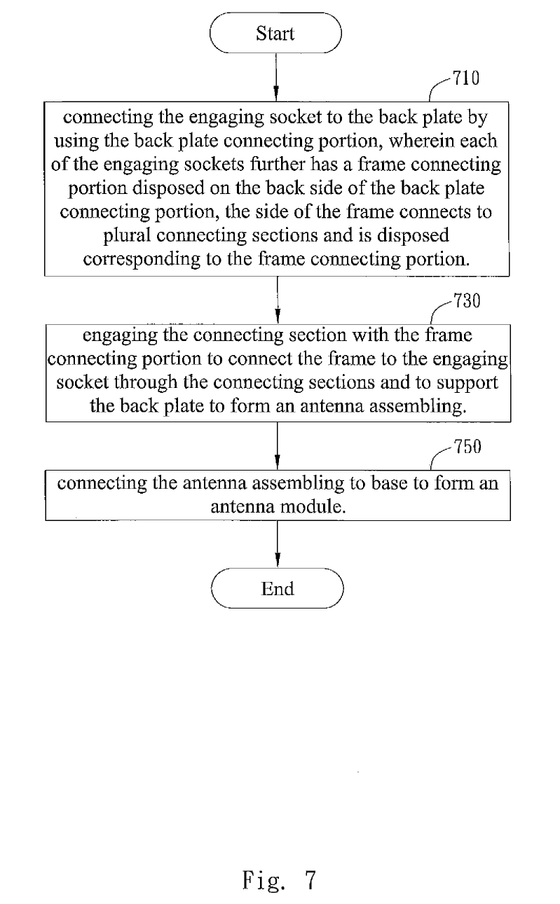

Another embodiment of the present invention also provides a manufacture method for an antenna module and the positioning device thereof to solve the limitation of assembling the Patch Antenna in wireless communication products. FIG. 7 illustrates the flow chart of the manufacture method of the antenna module and positioning device of the embodiment of the present invention. The antenna module of the embodiment of the present invention includes a frame, plural antenna sets and an antenna positioning device. Each of the antenna sets has a back plate. Plural antenna positioning devices have plural engaging sockets. Each of engaging sockets has a back plate connecting portion 510. With reference to FIG. 7, the manufacture method of the antenna module of the embodiment of the present invention includes following steps: first of all, step 710 includes connecting the engaging socket to the back plate by using the back plate connecting portion, wherein each of the engaging sockets further has a frame connecting portion disposed on the back side of the back plate connecting portion, the side of the frame connects to plural connecting sections and is disposed corresponding to the frame connecting portion; secondly, step 730 includes engaging the connecting section with the frame connecting portion to connect the frame to the engaging socket through the connecting sections and to support the back plate to form an antenna assembling; finally, step 750 includes connecting the antenna assembling to base to form an antenna module.

In the embodiment shown in FIG. 5a, because each of the frame connecting portions 520 has a first surface 521 and a first flexible arm 523 and each of the connecting sections 610 has a first opening 611, the assembling step of the connecting sections includes a compressing method to form the connecting sections 610 on the frame 600, wherein the connecting section 610 is used to detachably connect to the frame connecting portion 520 along the first surface 521 and to engage the first flexible arm 523 with the first opening 611. However, in other embodiments, the step described above includes a welding method to connect the connecting section 610 and the frame 600. By doing so, it allows the connecting section to engage with the frame connecting portion 520. Besides, with reference to FIG. 5a, each of the back plate 311 has at least a second opening 312. Each of the back plate connecting portion 510 further has at least a latch 511. Thus, the engaging socket connecting step 710 includes engaging the latch 511 with the second opening 312 to detachably connect the back plate 311 and the back plate connecting portion 510. In the embodiment shown in FIG. 5a, each of the back plate 311 further has a third opening 313. The back plate connecting portion 510 also includes a second flexible arm 512. Therefore, the engaging socket connecting step includes engaging the latch with the second opening and engaging the second flexible arm with the third opening.

With reference to FIG. 5a, because the frame includes a flexible metal material, the assembling antenna assembling step 750 further includes a polygon-shaped frame body formed by bending the continuous wire rod to allow the antenna assembling to form a structure with a star-shaped cross-section. Besides, in other embodiments, the assembled antenna assembling forming step includes a polygon frame body formed by bending the continuous frame which allows the antenna assembling to have a structure with polygon shaped cross-section. Based on the description above, according to the molding design of the above-mentioned components, the antenna positioning device of the embodiment of the present invention prevents the efficiency of Patch Antenna from disturbing by deformation in the plastic component appearance and error of antenna assembling. Furthermore, according to the design of the engaging socket, the engaging socket is used to assemble Patch Antenna without any screw and rivet which improves the assembling convenience. Finally, the designer of this business can design a better product without being restrained by the antenna shield so as to improve the vogue appearance and efficiency.

Although the embodiments of the present invention have been described herein, the above description is merely illustrative. Further modification of the embodiment of the invention herein disclosed will occur to those skilled in the respective arts and all such modifications are deemed to be within the scope of the invention as defined by the appended claims.

What is claimed is:

1. An antenna module for coupling with an electronic device, comprising:
a base having an axle;
a frame, disposed on the base; and
a plurality of antenna sets, assembled on the frame, wherein each of the antenna sets has an antenna and an antenna positioning device, the antenna positioning device further includes an engaging socket, the antenna sets engage with the frame through the engaging socket, and the antenna sets are disposed around the axle.

2. The antenna module of claim 1, wherein the antenna positioning device further includes a back plate, the engaging socket is disposed on the back side of the back plate and connects with a side of the frame.

3. The antenna module of claim 2, wherein the side of the frame has a plurality of connecting sections, the engaging socket further includes a back plate connecting portion and a frame connecting portion corresponding to the back side of the back plate connecting portion, the back plate connecting portion engages with the back plate, the connecting sections engage with the frame connecting portion.

4. The antenna module of claim 3, wherein the frame connecting portion includes a first surface and a first flexible arm, each of the connecting section has a first opening, wherein the first flexible arm detachably engages with the first opening when the connecting section engages with the frame connecting portion along the first surface.

5. The antenna module of claim 4, wherein the frame connecting portion further has an inner side, the first flexible arm connects to a first point of the inner side.

6. The antenna module of claim 4, wherein the frame connecting portion connects with a corner of the first surface by a plurality of positioning parts, each of the connecting sections has at least a hook, and both ends of the hook contact with the positioning part to connect the connecting section and the engaging socket when the first flexible arm engages with the first opening.

7. The antenna module of claim 3, wherein the back plate has at least a second opening, the back plate connecting portion further has at least a latch, the latch engages with the second opening to connect the back plate connecting portion and the back plate.

8. The antenna module of claim 7, wherein the back plate further has a third opening, the back plate connecting portion includes a second flexible arm, when the latch engages with the third opening, the second flexible arm engages with the third opening to detachably connect the back plate and the engaging socket.

9. The antenna module of claim 7, wherein the at least a latch is disposed on the edge of the back plate connecting portion.

10. The antenna module of claim 3, wherein the frame connecting portion further includes a first flexible arm and a base having an inner side, the inner side includes a first point and a second point, the back plate connecting portion has a second flexible arm, the first flexible arm connects with the first point, the second flexible arm connects with the second point, and an extending direction of the first flexible arm is parallel to an extending direction of the second flexible arm.

11. The antenna module of claim 1, wherein the frame is made of a metal material.

12. The antenna module of claim 1, wherein the frame is a polygon frame.

13. The antenna module of claim 1, wherein the frame is a polygon plate material.

14. The antenna module of claim 1, wherein the engaging socket is mold with a plastic material.

15. The antenna module of claim 3, wherein the frame connects the plurality of antenna sets to form an antenna assembling, the antenna assembling connects to the base and has an enclosure area accommodating the axle.

16. The antenna module of claim 17, wherein the enclosure area of the assembling antenna has a star-shaped cross-section.

17. The antenna module of claim 17, wherein the enclosure area has a polygon cross-section.

18. The antenna module of claim 2, wherein each of the engaging socket is disposed on a geometric center of each back plate, the edge of each connecting section perpendicularly connects to the side of the frame, when the connecting sections engages with the frame connecting portion, the side of the frame is partially disposed proximal to the back plate.
